(19) United States
(12) Patent Application Publication
(10) Pub. No.: US 2004/0031699 A1
(43) Pub. Date: Feb. 19, 2004

(54) Method for performing real time arcing detection

(75) Inventor: Sergio Fukuda Shoji, San Jose, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 10/224,304

(22) Filed: Aug. 19, 2002

(51) Int. Cl. G01N 27/26

(52) U.S. Cl. 205/791.5; 204/401

(57) ABSTRACT

A method of detecting arcing in a semiconductor substrate processing system. In one embodiment, the method includes monitoring a signal, identifying an indicia of arcing in the signal, and performing an action in response to the indicia of arcing when the indicia of arcing is identified.

### BACKGROUND OF THE INVENTION

1. Field of the Invention

Embodiments of the present invention generally relate to semiconductor substrate processing systems, and more specifically, to monitoring arcing that occurs within such processing systems.

2. Description of the Related Art

During the manufacture of semiconductor devices, electrostatic chucks provide more uniform clamping and better utilization of the surface of a substrate than mechanical chucks. Electrostatic chucks can also operate in vacuum chambers where the vacuum chucks cannot be used. As such, electrostatic chucks have found wide use in semiconductor substrate processing systems.

Operation of an electrostatic chuck is based on a well-known principle of creating a clamping force between the biased electrostatic chuck and a substrate (also referred to as a wafer). Generally, there are two basic configurations of an electrostatic chuck differentiated by the number of the electrodes—unipolar (or monopolar) chucks with one electrode and bipolar chucks with two electrodes. In either configuration, the electrodes are located in proximity to the surface that supports a substrate and embedded in or coated with a dielectric material such as polyamide, alumina, aluminum-nitride and the like. When electrically biased, these electrodes polarize the material of a substrate and develop a clamping force between the electrostatic chuck and the substrate. Typically, a DC voltage is used in an electrostatic chuck for clamping the substrates during plasma processing. However, AC voltage chucks are also known in the art.

A unipolar electrostatic chuck utilizes a plasma or an electrical contact to the substrate to complete a return path for the source of electrical bias, while a bipolar chuck needs only a differential voltage applied across the electrodes to create the clamping force and can operate in a non-plasma environment. In general, the DC voltage employed in an electrostatic chuck is quite high and may reach 700-1500 volts, however, voltage in a 200-700 volts range is more common.

When an electrostatic chuck is used in a plasma enhanced semiconductor wafer processing system, such as an etch chamber, a physical vapor deposition (PVD) chamber, or a plasma enhanced chemical vapor deposition (PECVD) chamber, or a reactive ion etch (RIE) chamber, the electrode(s) of the chuck draw current from the plasma or source current to the plasma depending on the polarity of the chucking voltage. Such current flow may not be uniform across the wafer and may result in wafer arcing and/or arcing between chamber components. Arcing may also occur for other reasons, including excessive power or localized impurities/contaminants accumulating on one or more components (or the substrate) within the processing system.

Arcing is a condition in which the region of current flow in a plasma, normally spread over a significant volume, collapses into a highly localized region (called an arcing region) that contains a concentrated arcing current. During arcing, due to the high concentration of power dissipation and the high speeds attained by electrons and ions in the arcing region, surfaces of the substrate or the system components can be altered or damaged from ion or electron implantation and/or localized heating (which can cause spalling). Although low-severity, occasional arcing that causes little or no damage frequently occurs during normal operation of a plasma enhanced semiconductor wafer processing system, high-severity or more frequent arcing can be a significant problem, such as, inferior performance (or even failure) of the circuits being processed. Severe arcing can also damage one or more components of the processing system, such that expensive components must be replaced. Furthermore, the processing system must be shut down to replace the damaged components and/or to correct the arcing problem. Even if components in the system are not damaged enough to require immediate replacement, pitting of the surfaces of the chamber, electrodes, or other components can cause particulates, which contaminate the system or the substrate. In addition, arcing can disrupt the electric fields that clamp the wafer to the electrostatic chuck, thereby causing the substrate to become unclamped or decoupled from the chuck.

Although high-severity arcing is sometimes visible as a flash of light, if the arcing is severe enough to see, the chamber or substrate has already likely been damaged. Moreover, low or moderately severe arcing (which can be a precursor to more severe arcs) is often difficult to detect. Further, once arcing has occurred, subsequent, potentially more severe arcing is more likely.

Therefore, a need exists in the art for a method and apparatus for monitoring and reducing arcing that occur in plasma enhanced semiconductor wafer processing systems.

### SUMMARY OF THE INVENTION

Embodiments of the present invention are generally directed to a method of detecting arcing in a semiconductor substrate processing system. In one embodiment, the method includes monitoring a signal, identifying an indicia of arcing in the signal, and performing an action in response to the indicia of arcing when the indicia of arcing is identified.

In another embodiment, the invention is directed to a method of operating an electrostatic chuck. The method includes applying a chucking voltage to the electrostatic chuck, applying a dechucking voltage to the electrostatic chuck, and applying a ramp down voltage prior to applying the dechucking voltage. The ramp down voltage is configured to provide a gradual transition from the chucking voltage to the dechucking voltage so as to reduce arcing during dechucking.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic diagram of semiconductor substrate processing system in accordance with one embodiment of the invention;

FIG. 2 illustrates a graph of forward RF power versus time during processing of a substrate in accordance with one embodiment of the invention;

FIG. 3 depicts a flow diagram of a process for detecting arcing in the system using forward RF power in accordance with one embodiment of the invention;

FIG. 4 illustrates a graph of electrostatic chuck current versus time during processing of a substrate in accordance with an embodiment of the invention;

FIG. 5 depicts a flow diagram of a process for detecting arcing in the system using electrostatic chuck current;

FIG. 6 depicts a flow diagram of a process for operating an electrostatic chuck in accordance with one embodiment of the invention;

FIG. 7 illustrates various graphs of electric signals as applied to a chuck to facilitate operation of the chuck in accordance with one embodiment of the invention; and

FIG. 8 is a graph illustrating the effect of ramping down a voltage set point KVSP in accordance with an embodiment of the invention.

### DETAILED DESCRIPTION OF THE PREFERRED EMBODIMENT

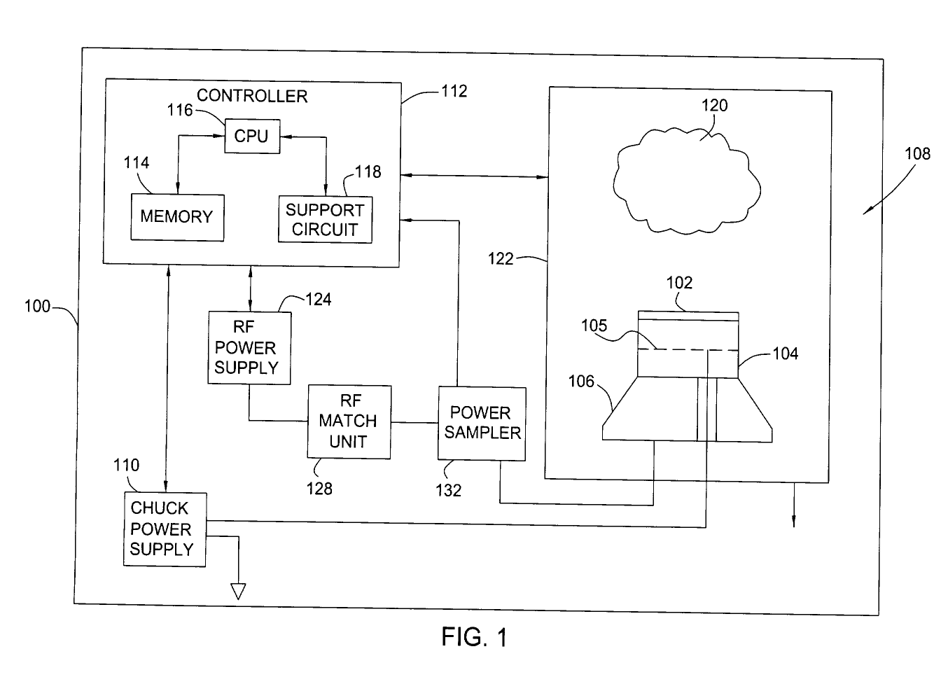

FIG. 1 depicts a schematic diagram of a semiconductor substrate processing system 100 having a controller 112, a chamber 108 with an electrostatic chuck 104, an RF power supply 124, an RF match unit 128, a power sampler 132, and a clamping power supply 110.

The controller 112 has a central processing unit (CPU) 116, a memory 114, and support circuits 118 for the CPU 116 and coupled to the various components of the system 100. To facilitate control of the chamber 108, the CPU 116 may be one of any form of general purpose computer processor that can be used in an industrial setting for controlling various chambers and subprocessors. The memory 114 is coupled to the CPU 116. The memory 114, or computer-readable medium, may be one or more of readily available memory, such as random access memory (RAM), read only memory (ROM), floppy disk, hard disk, or any other form of digital storage, local or remote. The support circuits 118 are coupled to the CPU 116 for supporting the processor in a conventional manner. These circuits may include cache, power supplies, clock circuits, input/output circuitry and subsystems, and the like.

A substrate 102 is placed on and removed from the chuck 104 by a robotic arm (not shown) of the system 100. The chuck 104 is generally a part of a substrate pedestal 106, which may also be adapted for conditioning and treatment of the substrate 102 such as cooling and heating by various means including backside gas, embedded heater, infrared radiation, and the like. The substrate 102 may also be treated in the chamber 108 by various non-plasma processes (irradiation by ultra violet and infrared light, heat treatments, annealing, and the like) in addition to plasma processing.

The pedestal 106 and other elements of the chamber 108, such as powered electrodes, internal and external inductive coils, sputtering targets, shields, and the like, may be electrically biased by power supplies operating in DC, AC or RF/microwave bands. Plasma may be formed by applying forward RF power to the pedestal (cathode) 106 via an RF power supply 124. The forward RF power is generally supplied to the cathode via a matching unit 128 and/or a power sampler 132. A grounded electrode (anode) may be positioned inside in the chamber 108, e.g., the chamber walls 122. The electric field generated between the anode and the cathode excites a process gas to an ionic or plasma state. Alternatively, plasma may be introduced to the chamber 108 from a remote source in the form of an ionized gas.

The chuck 104 includes one or more electrodes 105 that are operated by the clamping power supply 110. Generally, the power supply 110 is a controlled high voltage DC power supply that serves as a programmable source of the clamping voltages and clamping currents for the chuck 104. An example of such a power supply is disclosed in commonly assigned U.S. Pat. No. 6,005,376, issued Dec. 21, 1999, which is incorporated herein by reference. These clamping voltages and clamping currents are administered and monitored in real time by the controller 112 of the system 100 during processing of the substrate 102.

In general, various embodiments of the invention may be useful in any plasma enhanced semiconductor substrate processing chamber where arcing is detrimental to the processing of substrates. In one embodiment of the invention, the chamber 108 is an etch chamber such as the MxP, MxP+, eMxP, super e, and eMAX etch chambers manufactured by Applied Materials, Inc. of Santa Clara, Calif. In such an embodiment, the electrostatic chuck 104 includes a single electrode 105 (known as a unipolar chuck) that is coupled to the power supply 110. The return current path for the applied chucking voltage is through a plasma 120 to the grounded chamber walls 122. Alternatively, a bipolar chuck may be used, wherein a differential voltage is applied to a pair of electrodes to achieve chucking without a plasma forming a return current path.

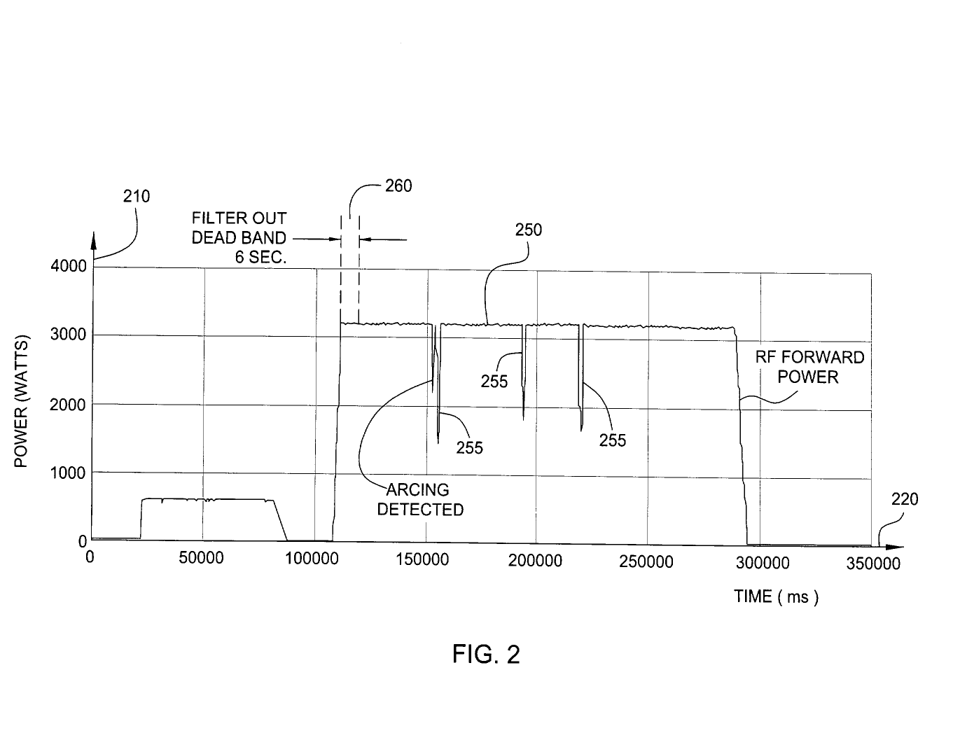

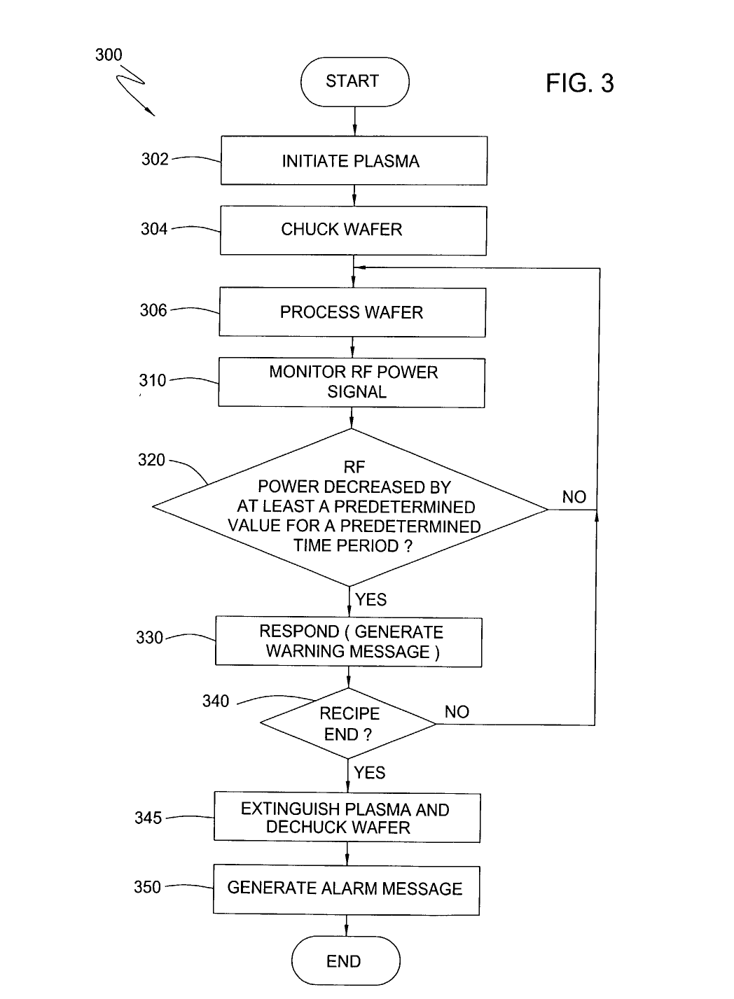

Recently, it has been observed that when arcing occurs in the system 100, particularly wafer arcing, the forward RF power applied to the pedestal (cathode) 106 drops or decreases by a significant amount for a short amount of time. FIG. 2 illustrates a graph of forward RF power (axis 210) versus time (axis 220) when arcing occurs in the system 100. The forward RF power 250 has a set point of 3200 Watts. When arcing occurs in the system 100, the forward RF power 250 decreases by a range from approximately 500 Watts to 1500 Watts for a period of approximately 200 to 250 milliseconds. Such decreases are identified by reference number 255. Therefore, certain embodiments of the invention are directed to a process 300 for detecting arcing in the system 100 by monitoring forward RF power, as illustrated in FIG. 3. The process 300 is configured to detect arcing that occurs during the entire time the substrate 102 is processed in the system 100, including chucking and dechucking. Furthermore, the process 300 may be implemented as a software program generally stored in the memory 114 that, when executed by the controller 112, causes the system 100 to operate in accordance with process 300. The program may also be stored and/or executed by a local controller (not shown) of the chamber 108 or by a CPU (not shown) that is remotely located from the hardware being controlled by the CPU 116.

The software program, when executed by the CPU 116, transforms the general purpose computer into a specific purpose computer (controller) 112 that controls operation of the chamber 108 such that the process 300 is performed. Although the process 300 is discussed as being implemented as a software routine, some of the method steps that are disclosed therein may be performed in hardware as well as by the software controller. As such, the process 300 may be implemented in software as executed upon a computer system, in hardware as an application specific integrated circuit or other type of hardware implementation, or a combination of software and hardware.

Referring now to FIG. 3, the process 300 begins at step 302 where a substrate is placed on the chuck 104 and plasma is ignited and stabilized. At step 304, the chuck electrode or electrodes 105 are energized to clamp and retain the substrate 102 on the chuck 104. At step 306, the processing of the substrate 102 begins. During processing, the forward RF power applied to the pedestal (cathode) 106 is monitored, for example, approximately every 25 ms (step 310). The forward RF power is generally supplied by the forward RF power supply 124 and sampled at the output of the matching unit 128 by the power sampler 132, e.g., an RF-to-DC converter driven by a directional coupler. The power sampler 132 is generally imbedded into the matching unit 128 or RF Power Supply 124, but may be a stand-alone component, as shown in FIG. 1. The DC voltage that represents the RF power is generally coupled to the controller 112 for digitization. Although the process 300 is described using forward RF power, other signals, such as reflected RF power may also be used to detect arcing in the system 100. In one embodiment, the RF power is continuously monitored in real time until arcing has been detected in the system 100. In another embodiment, the RF power is periodically monitored (e.g., sampled every 25 ms).

At step 320, a determination is made as to whether the forward RF power contains an indicia of arcing in the form of a short-term, dramatic change in power level. In one embodiment, a determination is made as to whether the forward RF power has decreased by at least a predetermined value for a predetermined time period. If the query is negatively answered, the process 300 returns to step 306 to continue processing the substrate 102. If the query is affirmatively answered, then a message is generated indicating to the operator that possible arcing has been detected in the system 100 (step 330). That is, arcing is only determined when an indicia of arcing is detected, e.g., when the forward RF power has decreased by at least the predetermined value for the predetermined time period. For example, the predetermined value may be approximately 200 Watts and the predetermined time period may be approximately 100 milliseconds. Using this example, arcing would not be detected if the forward RF power decreases by only 190 Watts for 200 milliseconds. Likewise, arcing would also not be detected if the forward RF power decreases by 300 Watts for 10 milliseconds and by 180 Watts for 300 milliseconds. On the other hand, arcing would be detected if the forward RF power decreases for 201 Watts for 125 milliseconds. The predetermined value and time period may vary based on process recipe and chamber conditions. The value and time period may also be changed after a first arc is detected to change the detection process sensitivity to a second arc. The detection process sensitivity may be increased or decreased depending upon the process circumstances. Further, the predetermined value and time period may be selected to avoid detecting noise and false arcing caused by various events, such as, reflected power surge in the beginning of a process and power spikes due to an impedance mismatch or a defective RF generator. To avoid false positive detection due to noise, the RF power signal may be filtered or processed prior to being monitored.

In one specific embodiment of the invention, the determination step of step 320 may be repeated for a number of periods. For example, the determination step may be set to repeat 3 times, the predetermined value may be set to approximately 60 Watts, and the predetermined time period may be set to approximately 25 milliseconds. If it is determined that the forward RF power has decreased by at least 60 Watts for 25 milliseconds, then the forward RF power is monitored for a second time to determine whether the same pattern is repeated. If so, the forward RF power may be monitored for a third time. If it is determined that the forward RF power has decreased by at least 60 Watts during all three periods (25 milliseconds each), then a message is generated indicating that possible arcing has been detected in the system 100. In this manner, possible arcing may be detected 75 milliseconds after the forward RF power has decreased by at least 60 Watts.

The message generated when an indicia of arcing has been detected may include reciting the forward RF power at the time the message is generated, the predetermined value, the power drop limit, and the recipe step during which the arcing has been detected. At step 340, a determination is made as to whether the process recipe at which arcing has been detected has ended. If the query is negatively answered, then the substrate 102 continues to be processed. On the other hand, if the query is affirmatively answered, then processing of the substrate 102 is halted and the chamber 108 is faulted. At step 345, the plasma is terminated, the chuck electrode or electrodes are deenergized, and a dechucking voltage is applied to dechuck or declamp the substrate 102. At step 350, another message may be generated to alarm the operator that processing of the substrate 102 has been halted due to possible arcing in the system 100. In addition to or in lieu of a warning message, the system 100 may automatically prevent further arcing from occurring by adjusting the forward RF power or chucking voltage.

In certain systems, the forward RF power at the beginning of each recipe step may be unstable, thereby causing false detection. Accordingly, in these systems, the forward RF power is not monitored until after a predetermined delay time period has passed so as to ensure that the forward RF power has reached a point of stability. For example, the forward RF power may only be monitored 6 seconds after the forward RF power reaches a set point (see delay 260 in FIG. 2).

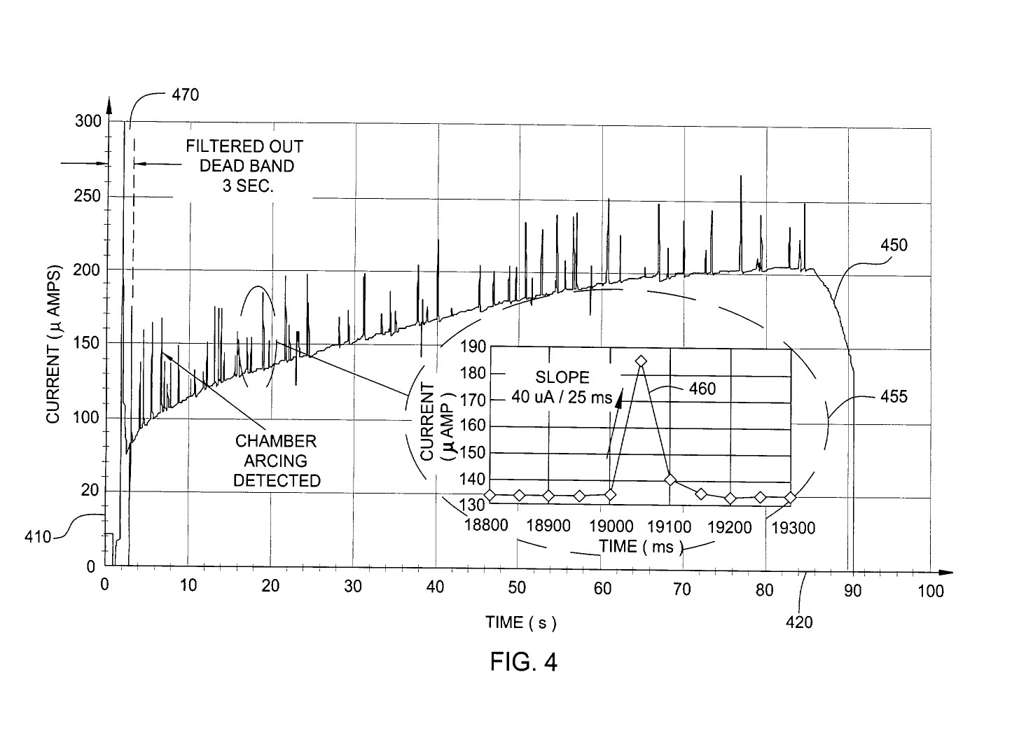

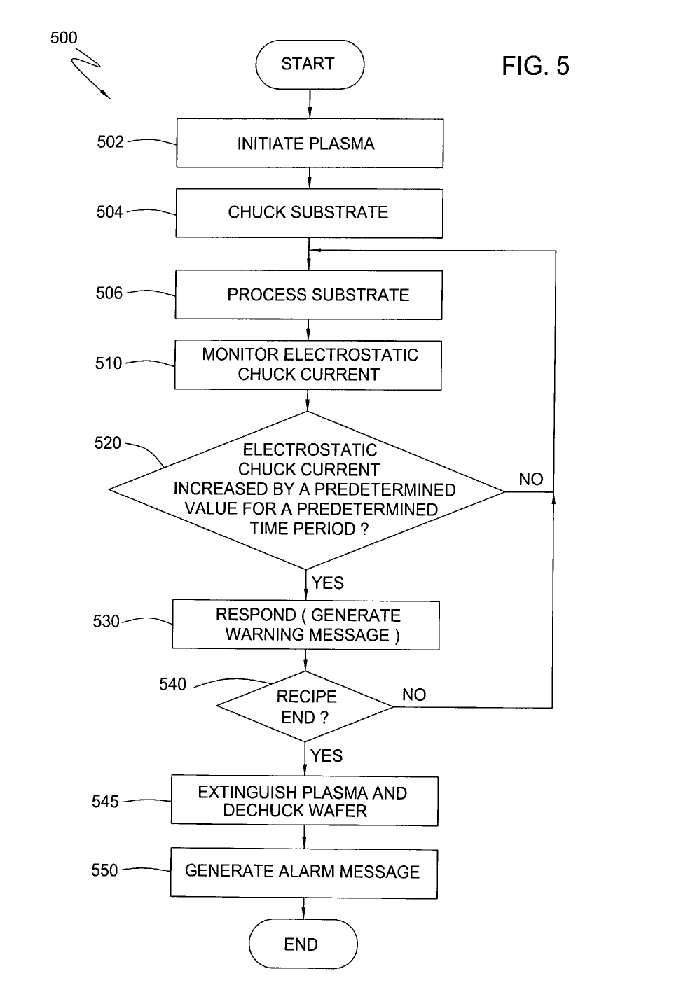

Recently, it has also been observed that when arcing occurs in the system 100, particularly chamber arcing, the leakage or electrostatic chuck current (I_{ESC}) increases or spikes by a significant amount for a short amount of time. FIG. 4 illustrates a graph of an electrostatic chuck current (axis 410) versus time (axis 420) when chamber arcing occurs in the system 100. When arcing occurs, the electrostatic chuck current 450 generally increases by at least 20 micro amps for a period of 25 milliseconds, i.e., a slope of 20 micro amps per 25 milliseconds. Spike 460 in the inset 455 illustrates such an increase. Accordingly, certain embodiments of the invention are directed to a process 500 for detecting arcing in the system 100 by monitoring electrostatic chuck current (I_{ESC}), as illustrated in FIG. 5. The process 500 is configured to detect arcing that occurs during the entire time the substrate 102 is processed in the system 100, including chucking and dechucking. The process 500 may be implemented as a software program generally stored in the memory 114 that, when executed by the controller 112, causes the system 100 to operate in accordance with process 500. The program may also be stored and/or executed by a local controller (not shown) of the chamber 108 or by a CPU (not shown) that is remotely located from the hardware being controlled by the CPU 116.

The software program, when executed by the CPU 116, transforms the general purpose computer into a specific purpose computer (controller) 112 that controls operation of the chamber 108 such that the process 500 is performed. Although the process 500 is discussed as being implemented as a software routine, some of the method steps that are disclosed therein may be performed in hardware as well as by the software controller. As such, the process 500 may be implemented in software as executed upon a computer system, in hardware as an application specific integrated circuit or other type of hardware implementation, or a combination of software and hardware.

Referring now to FIG. 5, the process 500 begins at step 502 where a substrate is placed on the chuck 104 and plasma is ignited and stabilized. At step 504, the chuck electrode or electrodes 105 are energized to clamp and retain the substrate 102 on the chuck 104. At step 506, the processing of the substrate 102 begins. During processing, the electrostatic chuck current is monitored, for example, approximately every 25 ms (step 510). In one embodiment, the electrostatic chuck current may be monitored in real time. At step 520, a determination is made as to whether the electrostatic chuck current has increased or spiked by at least a predetermined value for a predetermined time period. If the query is negatively answered, processing returns to step 506 to continue processing the substrate 102. If the query is affirmatively answered, then a message is generated indicating to the operator that possible arcing has been detected in the system 100 (step 530). In this manner, arcing is only determined when an indicia of arcing has been detected, e.g., when the electrostatic chuck current has increased by at least the predetermined value for the predetermined time period. For example, the predetermined value may be approximately 20 micro amps and the predetermined time period may be approximately 25 milliseconds. The predetermined value and time period may vary based on process recipe and chamber conditions. The value and time period may also be changed after a first arc is detected to change the detection process sensitivity to a second arc. The detection process sensitivity may be increased or decreased depending upon the process circumstances. Further, the predetermined value and time period may be selected to avoid detecting noise and false arcing that may be caused by events, such as, reflected power surge in the beginning of a process and power spikes due to an impedance mismatch. To avoid false positive detection due to noise, the chuck current may be filtered or processed prior to being monitored.

The message generated when an indicia of arcing has been detected may include reciting the electrostatic chuck current at the time the message is generated, the predetermined value, and the recipe step during which the arcing has been detected. At step 540, a determination is made as to whether the recipe at which arcing has been detected has ended. If the query is negatively answered, then the substrate 102 continues to be processed. On the other hand, if the query is affirmatively answered, then processing of the substrate 102 is halted and the chamber 108 is faulted. At step 545, the plasma is terminated and the chuck electrode or electrodes are deenergized and a dechucking voltage is applied to dechuck or declamp the substrate 102. At step 550, another message may be generated to alarm the operator that processing of the substrate 102 has been halted due to possible arcing in the system 100 (step 550). In addition to or in lieu of a warning message, the system 100 may automatically prevent further arcing from occurring by adjusting the electrostatic chuck current.

In certain systems, the electrostatic chuck current at the beginning of each recipe step may be unstable, thereby causing false detection. Accordingly, in these systems, the electrostatic chuck current is not monitored until after a predetermined delay time period has passed so as to ensure that the electrostatic chuck current has reached a point of stability. For example, the electrostatic chuck current may only be monitored 3 seconds after the electrostatic chuck current reaches a set point (see delay 470 in FIG. 4).

Recently, it has also been discovered that wafer arcing frequently occurs during dechucking, and that wafer arcing may be limited by gradually transitioning the chucking voltage to the dechucking voltage during dechucking. Accordingly, certain embodiments of the invention are directed to a new method for operating an electrostatic chuck, which includes a feature for suppressing or reducing arcing during dechucking.

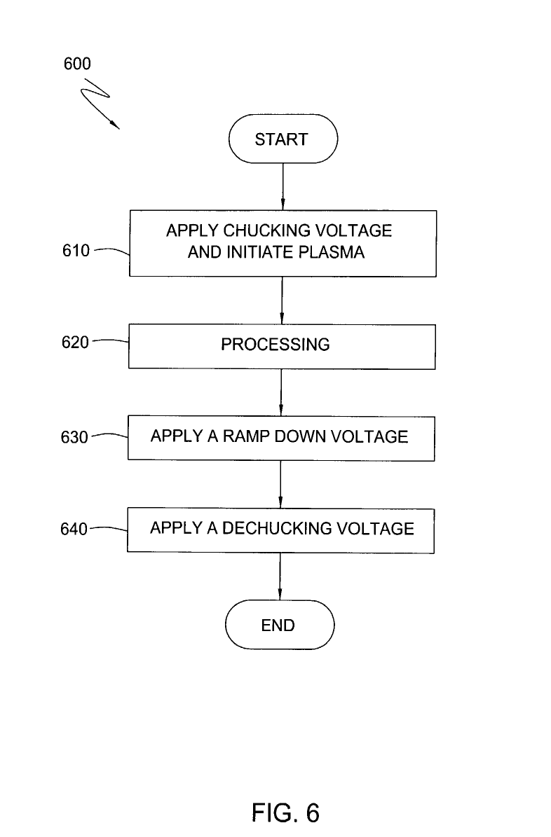

FIG. 6 illustrates a process 600 for operating the electrostatic chuck 104 in accordance with one embodiment of the invention. The process 600 may be implemented as a software program generally stored in the memory 114 that, when executed by the controller 112, causes the system 100 to operate in accordance with process 600. The program may also be stored and/or executed by a local controller (not shown) of the chamber 108 or by a CPU (not shown) that is remotely located from the hardware being controlled by the CPU 116.

The software program, when executed by the CPU 116, transforms the general purpose computer into a specific purpose computer (controller) 112 that controls operation of the chamber 108 such that the process 600 is performed. Although the process 600 is discussed as being implemented as a software routine, some of the method steps that are disclosed therein may be performed in hardware as well as by the software controller. As such, the process 600 may be implemented in software as executed upon a computer system, in hardware as an application specific integrated circuit or other type of hardware implementation, or a combination of software and hardware.

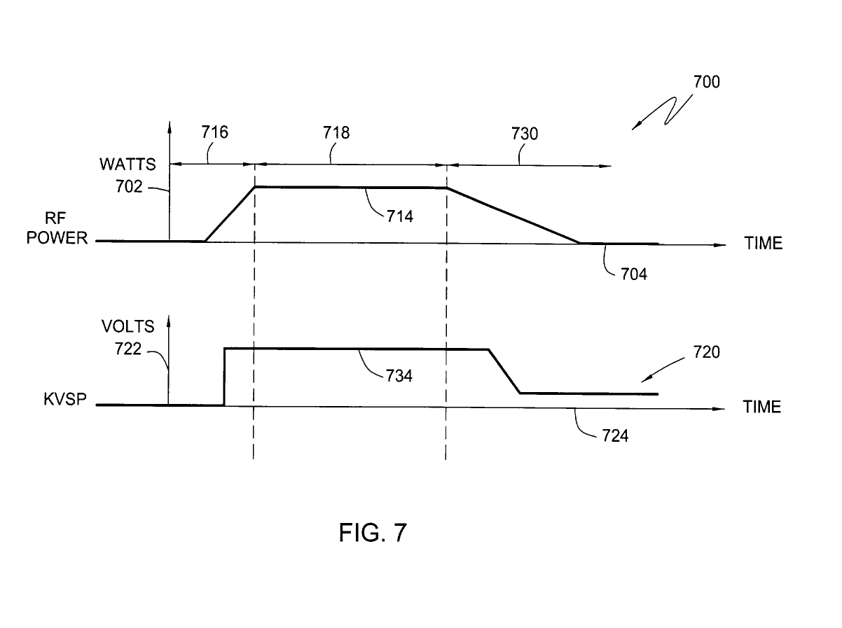

The process 600 begins at step 610 where a substrate is placed on the chuck 104, plasma is ignited and stabilized, and a chucking voltage is applied to the electrostatic chuck 104. Embodiments of the invention may be used with any type of electrostatic chuck, including dielectric chucks, ceramic chucks, and the like. Once the chucking voltage is applied, opposite polarity charges are induced on the substrate 102 and the electrode(s), respectively. The electrostatic attractive force between the opposite charges presses the substrate 102 against the chuck 104, thereby retaining the substrate 102. Once the substrate 102 is retained, processing of the substrate 102 begins (step 620). When processing is complete, a ramp down voltage is applied to the chuck 104 (step 630), prior to applying a voltage for dechucking (i.e., dechucking voltage) (step 640). The ramp down voltage is configured to suppress or limit the electrostatic chuck current arcing during dechucking. By providing a gradual transition from the chucking voltage to the dechucking voltage, arcing, e.g., wafer arcing, during dechucking may be limited. The gradual transition may be facilitated by changing or updating the ramp down voltage every 100 milliseconds. The ramp down voltage may be applied for any time period sufficient to reduce arcing without adversely affecting any dechucking parameters, such as, substrate rotations, substrate extensions, and dechucking voltage window. As an example, for a 300 mm eMAX etch chamber, the ramp down voltage is applied for approximately 2 seconds, followed by the dechucking voltage for 3 seconds. Although a linear ramp down voltage is illustrated in FIG. 7, those skilled in the art will realize from the discussion herein that embodiments of the invention may be used with any type of ramp down voltage, including sinusoidal, saw tooth, stepped and the like. Once dechucking is complete, the substrate 102 may be physically removed from the chuck 104.

FIG. 7 depicts various graphs of electric signals that are applied to the chuck 104 to facilitate operation of the chuck 104 in accordance with one embodiment of the invention. Graph 700 depicts RF power (axis 702) versus time (axis 704) and graph 720 depicts voltage set point for chucking and dechucking (KVSP) (axis 722) versus time (axis 724). In graph 700, the RF power 714 is applied during a first period 716, the substrate 102 is processed with plasma during period 718, and when the substrate requires dechucking, the plasma is terminated at some point during period 730.

In graph 720, the KVSP 734, once activated, is applied at a steady state, i.e., chucking voltage, during both periods 716 and 718 to chuck the substrate 102. During period 730, the KVSP 734 continues at the same level, i.e., chucking voltage, for a short period of time (helium dump time) sufficient to dump or remove helium from beneath the substrate out of the system 100. As an example, for a 300 mm eMAX etch chamber, the helium dump time is approximately 1 second. The KVSP 734 is subsequently ramped down to a dechucking voltage level. The KVSP 734 may be ramped down for a period of time sufficient to reduce the electrostatic chuck current arcing during dechucking. As an example, for a 300 mm eMAX etch chamber, the KVSP 734 may be ramped down for approximately 2 seconds to reduce the electrostatic chuck current arcing without adversely affecting any dechucking parameters, such as, substrate rotations, substrate extensions and dechucking voltage window.

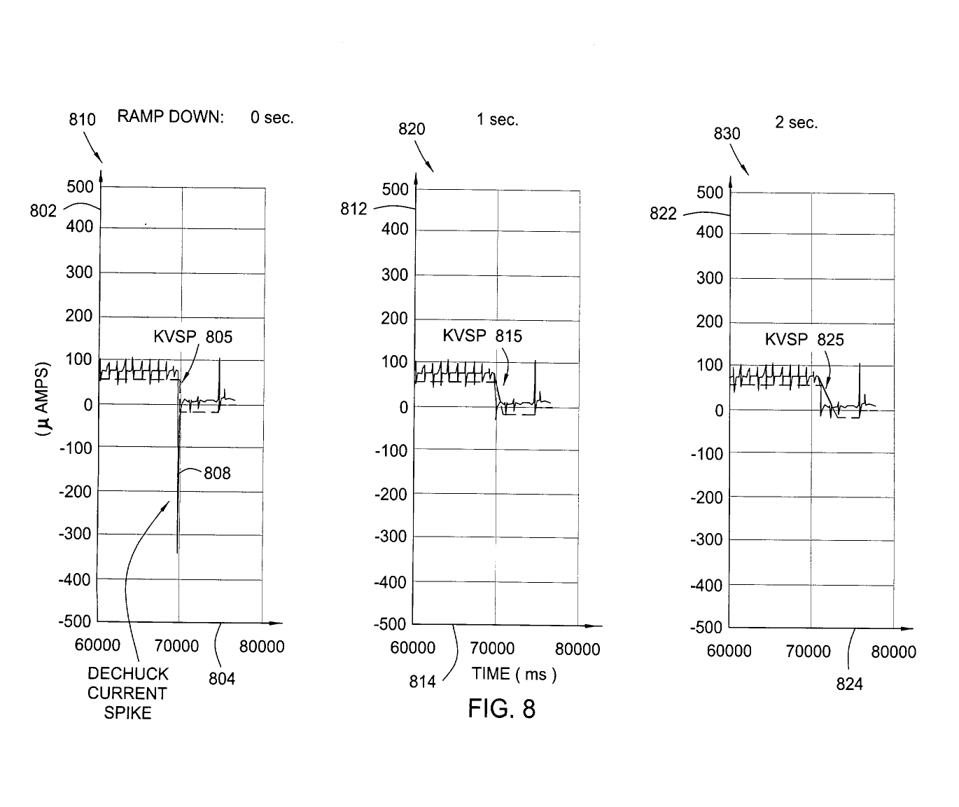

FIG. 8 is a compilation of graphs illustrating the effect of ramping down a voltage set point KVSP in accordance with an embodiment of the invention. Graph 810 illustrates KVSP and electrostatic chuck current (axis 802) versus time (axis 804). When KVSP 805 makes a sudden transition from a chucking voltage to a dechucking voltage, the electrostatic chuck current 808 spikes, thereby indicating that an arc could have been induced. Graph 820 illustrates KVSP and electrostatic chuck current (axis 812) versus time (axis 814). When KVSP 815 makes a gradual transition for a period of 1 second from a chucking voltage to a dechucking voltage, the spike (or arc indicia) that was previously shown in graph 810 is minimized. Graph 830 illustrates KVSP and electrostatic chuck current (axis 822) versus time (axis 824). When KVSP 825 makes a gradual transition for a period of 2 seconds from a chucking voltage to a dechucking voltage, the spike (or arc indicia) that was previously shown in graph 810 is further minimized.

The foregoing process and apparatus may be used with either a uni-polar chuck or a bipolar chuck. For a bipolar chuck, the KVSP controls the differential voltage applied across a pair of electrodes.

While the foregoing is directed to embodiments of the present invention, other and further embodiments of the invention may be devised without departing from the basic scope thereof, and the scope thereof is determined by the claims that follow.

What is claimed is:

1. A method of detecting arcing in a semiconductor substrate processing system, comprising:
monitoring a signal;
identifying an indicia of arcing in the signal; and
performing, when the indicia of arcing is identified, an action in response to the indicia of arcing.

2. The method of claim 1, wherein the action is at least one of generating a message indicating that arcing has been detected and adjusting one or more parameters applied to a process chamber.

3. The method of claim 1, wherein the signal is a forward radio frequency (RF) power.

4. The method of claim 1, wherein the identifying step comprises determining whether the forward RF power decreases by at least a predetermined value for a predetermined period of time.

5. The method of claim 4, wherein the predetermined value is approximately 200 Watts.

6. The method of claim 4, wherein the predetermined period of time is approximately 100 milliseconds.

7. The method of claim 4, wherein the predetermined value is approximately 200 Watts and the predetermined period of time is approximately 100 milliseconds.

8. The method of claim 1, wherein the semiconductor substrate processing system is a plasma enhanced semiconductor etching system.

9. The method of claim 4, wherein the message includes at least one of the forward RF power at the time the message is generated, the predetermined value and a recipe step during which arcing has been detected.

10. The method of claim 4, wherein the forward RF power is determined a predetermined delay time period after applying RF power to a process chamber.

11. The method of claim 10, wherein the predetermined delay time period is approximately 6 seconds.

12. The method of claim 4, further comprising repeating the determining step a number of times.

13. The method of claim 12, wherein the predetermined value is approximately 60 Watts and the predetermined period of time is approximately 25 milliseconds.

14. The method of claim 12, wherein the number of times is 3.

15. The method of claim 1, wherein the signal is an electrostatic chuck current.

16. The method of claim 15, wherein the identifying step comprises determining whether the electrostatic chuck current increases by at least a predetermined value for a predetermined time period.

17. The method of claim 16, wherein the predetermined value is approximately 20 micro amps.

18. The method of claim 16, wherein the predetermined time period is approximately 25 milliseconds.

19. The method of claim 16, wherein the predetermined value is approximately 20 micro amps and the predetermined time period is approximately 25 milliseconds.

20. The method of claim 16, wherein the electrostatic chuck current is determined a predetermined delay time period after the electrostatic chuck current reaches a set point value.

21. The method of claim 16, wherein the message includes at least one of the electrostatic chuck current at the time the message is generated, the predetermined value, and a recipe step during which arcing has been detected.

22. The method of claim 1, further comprising applying a ramp down voltage prior to applying a dechucking voltage, the ramp down voltage being configured to provide a gradual transition from the chucking voltage to the dechucking voltage.

23. A method of operating an electrostatic chuck, comprising:
applying a chucking voltage to the electrostatic chuck;
applying a dechucking voltage to the electrostatic chuck; and
applying a ramp down voltage prior to applying the dechucking voltage, the ramp down voltage being configured to provide a gradual transition from the chucking voltage to the dechucking voltage so as to reduce arcing during dechucking.

24. The method of claim 23, wherein the ramp down voltage is one of sinusoidal, saw tooth and stepped.

25. The method of claim 23, wherein the ramp down voltage is updated every 100 milliseconds so as to provide the gradual transition from the chucking voltage to the dechucking voltage.

26. The method of claim 23, wherein the ramp down voltage is applied for at least 2 seconds.

27. The method of claim 23, wherein the semiconductor substrate processing system is a plasma enhanced semiconductor etching system.

28. The method of claim 23, wherein the electrostatic chuck is one of a unipolar electrostatic chuck and a bipolar electrostatic chuck.

29. A computer readable medium containing a program that, when executed by a computer, causes a semiconductor substrate processing system to perform a method comprising:
monitoring a signal;
identifying an indicia of arcing in the signal; and
performing, when the indicia of arcing is identified, an action in response to the indicia of arcing.

30. The computer readable medium of claim 29, wherein the action is at least one of generating a message indicating that arcing has been detected and adjusting one or more parameters applied to a process chamber.

31. The computer readable medium of claim 29, wherein the signal is a forward radio frequency (RF) power.

32. The computer readable medium of claim 31, wherein the identifying step comprises determining whether the forward RF power decreases by at least a predetermined value for a predetermined period of time.

33. The computer readable medium of claim 31, wherein the forward RF power is determined a predetermined delay time period after applying RF power to a process chamber.

34. The computer readable medium of claim 33, wherein the predetermined delay time period is approximately 6 seconds.

35. The computer readable medium of claim 29, wherein the signal is an electrostatic chuck current.

36. The computer readable medium of claim 32, wherein the identifying step comprises determining whether the electrostatic chuck current increases by at least a predetermined value for a predetermined time period.

37. The computer readable medium of claim 29, wherein the electrostatic chuck current is determined a predetermined delay time period after the electrostatic chuck current reaches a set point value.

38. A computer readable medium containing a program that, when executed by a computer, causes a semiconductor substrate processing system to perform a method comprising:
applying a chucking voltage to the electrostatic chuck;
applying a dechucking voltage to the electrostatic chuck; and
applying a ramp down voltage prior to applying the dechucking voltage, the ramp down voltage being configured to provide a gradual transition from the chucking voltage to the dechucking voltage so as to reduce arcing during dechucking.
